(19) United States
(12) Patent Application Publication
(10) Pub. No.: US 2010/0065395 A1
(43) Pub. Date: Mar. 18, 2010

(54) MULTIPLATE WET CLUTCH

(75) Inventors: Andreas Baer, Lampertheim (DE); Guenter Weber, Deutsch Kaltenbrunn (AT); Manfred Hofer, Graz (AT)

Correspondence Address: HARNESS, DICKEY & PIERCE, P.L.C., P.O. BOX 828, BLOOMFIELD HILLS, MI, 48303, US

(73) Assignee: MAGNA Powertrain AG & Co KG, Lannach (AT)

(21) Appl. No.: 12/374,707

(22) PCT Filed: Jun. 20, 2007
(86) PCT No.: PCT/EP2007/005452

§ 371 Date: Nov. 18, 2009

(30) Foreign Application Priority Data
Jul. 24, 2006 (DE) 10 2006 034 154.6

(51) Int. Cl. F16D 13/52; F16D 13/72

(52) U.S. Cl. 192/70.2

(57) ABSTRACT

The invention relates to a multiplate wet clutch with a rotatable clutch hub which is rotationally fixedly connected to a plurality of inner plates which can be placed in frictional engagement with outer plates of an associated clutch cage, wherein the multiplate wet clutch has at least one fluid inlet opening which permits a fluid flow out of a fluid supply space to the plates. Arranged in the fluid flow path between the fluid inlet opening and the plates is at least one particle retention device.

The invention relates to a wet multidisk clutch having a rotatable clutch hub which is rotationally fixedly connected to a plurality of inner disks which can be brought into friction locking with outer disks of an associated clutch basket, wherein the wet multidisk clutch has at least one fluid inlet opening which allows a fluid flow from a fluid supply space to the disks.

Such a wet multidisk clutch serves for the adjustable transmission of a torque between a first shaft which is rotationally fixedly connected to the clutch hub (e.g. a transmission input shaft) and a second shaft which is rotationally fixedly connected to the clutch basket (e.g. a crankshaft of an internal combustion engine, a chain wheel shaft of a transfer case). A fluid, usually an oil which can also be applied to another assembly—for example an associated transmission—flows through the clutch for lubrication and cooling purposes. For this purpose, the fluid moves from a fluid supply space, for example from the inner space of a hollow shaft rotationally fixedly connected to the clutch hub, through one or more fluid inlet openings into the inner space of the clutch and in particular to the friction disks. It proves to be problematic in this respect that metal particles, for example metal wear debris from a transmission associated with the same fluid circuit, which are transported to the disks by the oil can impair the coefficient of friction characteristics of the disks, result in friction vibrations and noise formation and/or reduce the service life of the clutch.

It is the underlying object of the invention to provide a wet multidisk clutch of the initially named kind whose problem-free function is reliably ensured in the long term.

The object is satisfied by a wet multidisk clutch having the features of claim 1 and in particular in that at least one particle retention device is arranged in the fluid flow path between the fluid inlet opening and the disks.

Contamination particles, in particular metal particles, moving along with the fluid flow and entering into the clutch from the fluid supply space are collected and retained by the particle retention device so that these particles cannot move to the clutch disks. In other words, the particle retention device ensures that substantially particle-free fluid flows to the disks. The particle retention device is not necessarily flowed through by the fluid in the sense of a filter. It is only important that the particle retention device captures and retains the particles.

In this manner, not only an impairment of the coefficient of friction characteristics of the disks by contamination particles is avoided, but also unwanted friction vibrations and noise formation at the clutch disks are effectively prevented. In addition, the removal of the particles from the fluid in accordance with the invention, i.e. that is the purification of the fluid, results in an increase in the service life of the tribological system, whereby an optimum cooperation of the disks and thus a problem-free function of the clutch is ensured in the long term.

Advantageous embodiments of the invention can be seen from the dependent claims, from the description and from the drawing.

The particle retention device is preferably arranged radially in alignment with the respective fluid inlet opening with respect to the axis of rotation of the clutch hub, in particular radially outwardly spaced apart from the fluid inlet opening. The particle retention device can hereby be particularly effectively acted on by the particles on which the centrifugal force acts in the radial direction with a rotating clutch hub in order to collect the particles and hold them back from the fluid flow. The fluid liberated from the contamination particles can evade or escape from the particle retention device in the lateral direction—i.e. in the axial direction with respect to the axis of rotation of the clutch—for example.

In accordance with an embodiment, the particle retention device has, at least viewed in the radial direction, an outwardly terminated retention space and at least one passage which allows an exit of fluid from the retention space in the lateral or axial direction with respect to the axis of rotation of the clutch hub. The retention space is preferably closed in another lateral or axial direction. The fluid flow interspersed with particles therefore moves through the fluid inlet opening of the clutch hub to the particle retention device. The particles located in the fluid are accelerated radially outwardly by a rotation of the clutch hub due to their mass of inertia and are thus hurled into the particle retention device.

While the particles collect in the closed outer region of the retention space, the fluid flowing to the particle retention device is dammed in the retention space in order ultimately to escape from the particular retention device through the passage and to flow substantially free of particles to the disks.

The separation of particles and fluid in other words takes place in the manner of a centrifuge. The particle retention device is therefore not a filter which is clogged by the filtered particles over time and which thereby restricts the fluid flow. Instead, the passage allows an unrestricted exit of the fluid dammed in the retention space from the particle retention device at any time, whereby a substantially constant fluid flow to the disks is ensured in the long term.

The passage is advantageously—again with respect to the axis of rotation of the clutch hub—arranged in an inner region of the particle retention device, viewed in the radial direction. In this manner, the passage is at a maximum distance from the closed outer region of the retention space in which the particles collect which have been separated from the fluid by the centrifugal force. An even better freedom from particles of the fluid exiting the particle retention device and flowing to the disks is thereby achieved.

In accordance with a further embodiment, the particle retention device includes a fabric insert. The fabric insert contributes toward a particularly effective retention of the particles in the particle retention device. The fabric insert can comprise a fabric of metal and in particular of steel.

The fabric insert is advantageously arranged, viewed in the radial direction, in an outer region of a retention space of the particle retention device. The fabric insert thereby particularly effectively prevents the particles captured and compressed in the outer region of the retention space by the centrifugal force from being taken along by the fluid exiting the particle retention device, e.g. due to a swirling of the fluid dammed in the retention space, and from reaching the disks.

In accordance with a further embodiment, the particle retention device is made in the form of a retention ring surrounding the clutch hub. The retention ring represents a particularly simple and cost-effective construction shape of the particle retention device and allows a separation of particles and fluid in a simple manner even when the entry of the fluid into the clutch takes place at a plurality of fluid inlet openings arranged distributed over the periphery of the clutch hub.

The retention ring can be arranged in the region of the fluid inlet openings of the clutch hub and can in particular cover them—again viewed in the radial direction. It is ensured in this manner that fluid which flows through the bores and which is radially outwardly accelerated on a rotation of the clutch hub due to the centrifugal force enters into the retention ring and that the particles transported along by the fluid are hurled directly into a retention space of the retention ring.

The retention ring preferably has a substantially U-shaped cross-section which is inwardly open in the radial direction with respect to the axis of rotation of the clutch hub. In other words, the retention ring in this embodiment is made in the manner of a peripheral groove. Such a retention ring can extend in a dome-like manner over the fluid inlet openings of the clutch hub and can not only particularly effectively dam the fluid flow entering from the fluid supply space, but can also particularly effectively capture and retain the radially outwardly accelerated particles.

The retention ring can have a plurality of support webs which are arranged distributed in the peripheral direction, which project from a limb of the U cross-section and which extend radially inwardly. The retention ring is supported via the support webs at the clutch hub; in other words, the support webs therefore serve for the fixing of the retention ring at the clutch hub. A latch connection effective in the axial direction—related to the axis of rotation of the clutch hub—is preferably hereby realized.

The support webs are advantageously dimensioned such that a respective gap serving as a passage is formed between adjacent support webs between the retention ring and the clutch hub and fluid can flow through said gap out of the retention ring laterally or in the axial direction. The gaps combine to form a ring gap which is interrupted by the support webs in the peripheral direction, which surrounds the clutch hub and through which the fluid dammed in the retention ring and substantially liberated from particles can escape laterally or in the axial direction.

Since the ring gap is formed at the inner side of the retention ring viewed in the radial direction, it has a maximum distance from the closed outer region of the retention ring in which the particles separated from the fluid collect. This substantially contributes to the fluid exiting the retention ring being at least approximately free of particles.

To ensure a secure seating of the retention ring on the clutch hub, the support webs are preferably supported in a guide of the clutch hub.

The guide can be made such that a side of the retention ring supported in the guide, in particular the side remote from a passage or from the passages for the fluid, is pressed toward a radially extending wall section of the clutch hub. By the pressing of the ring side toward the radial wall section, a specific sealing effect is achieved which provides that the fluid dammed in the retention ring can only escape from the retention ring through the passage or passages. In this manner, a controlled flow of the fluid through the retention spring is ensured and an optimum retention of the particles to be separated from the fluid is ensured.

The guide can be formed by a recess extending in the peripheral direction that is by a groove or the like. Such a guide not only ensures a secure seat of the retention ring on the clutch hub, but also allows a particularly simple installation of the retention ring in that it only has to be pushed onto the clutch hub so that the support webs latch in the recess or groove.

The invention will be described in the following purely by way of example with reference to an advantageous embodiment and to the drawing. There are shown:

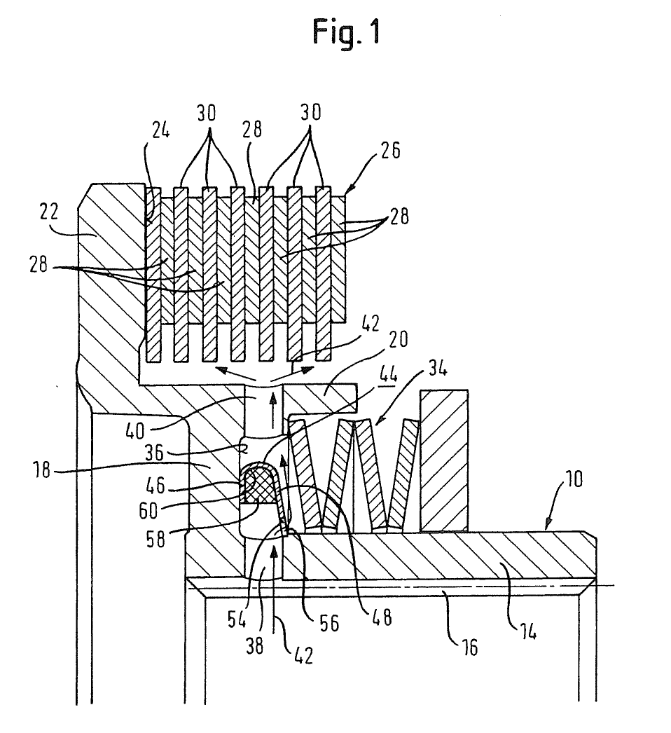

FIG. 1 a schematic longitudinal section of a part of a wet multidisk clutch in accordance with the invention;

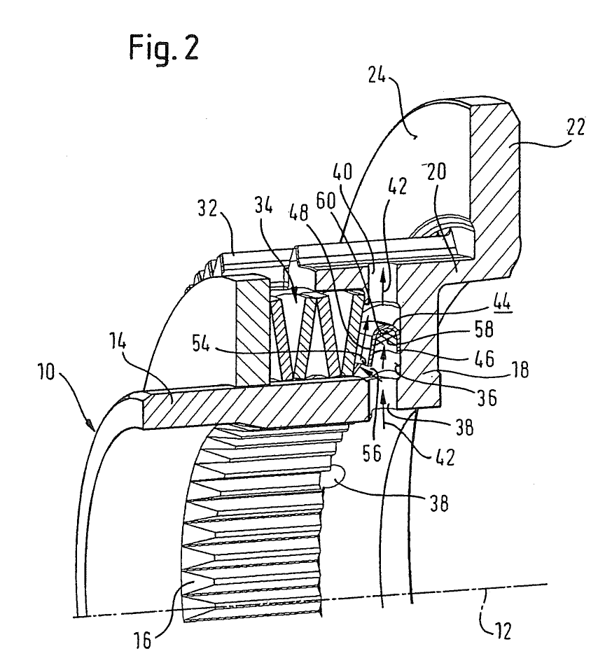

FIG. 2 a perspective view of a cut-away part of the clutch of FIG. 1; and

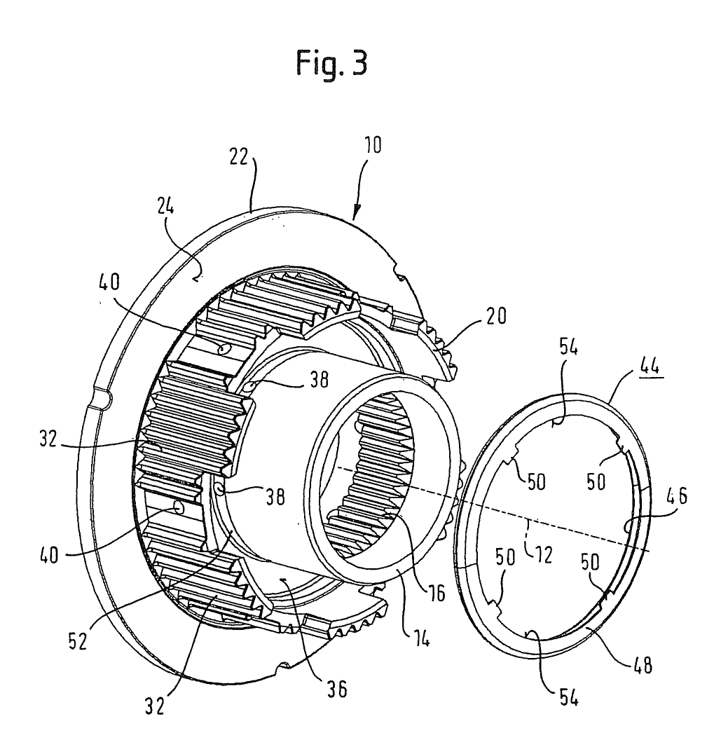

FIG. 3 a perspective view of a clutch hub and of a particle retention device of the clutch of FIG. 1.

The wet multidisk clutch shown in the Figures includes a rotationally supported clutch hub 10 which is made rotationally symmetrical with respect to a longitudinal central axis 12. The longitudinal central axis 12 corresponds to the axis of rotation of the clutch hub 10 and is used in the following as the reference axis for the terms “axial” and “radial”.

The clutch 10 has a shaft section 14 which is hollow cylindrical and at whose inner side an inner toothed arrangement 16 is provided. The shaft section 14 serves for the reception of a first shaft not shown in the Figures, for example of a transmission input shaft which has, at its outer side, an outer toothed arrangement which can be brought into engagement with the inner toothed arrangement 16 of the shaft section 14 to provide a connection of the clutch hub 10 and of the first shaft secure against twisting.

At its front end viewed in the axial direction, the shaft section 14 merges into a first wall section 18 extending in the radial direction. A hollow cylindrical shoulder section 20 which is oriented parallel to the shaft section 14 and which forms a T with the radial wall section viewed in the longitudinal section adjoins the outer end of the radial wall section 18 viewed in the radial direction. At its front end viewed in the axial direction, the shaft section 20 merges into a second wall section 22 extending outwardly in the radial direction.

A disk packet 26 which surrounds the shoulder section 20 is arranged at a rear side 24 of the second radial wall section 22 and includes a plurality of outer disks 28 and inner disks 30 which are arranged alternately in the axial direction and which are displaceably supported with respect to the clutch hub 10 in the axial direction.

The outer disks 28 are rotationally fixedly connected to a clutch basket which is not shown in the Figures, which is likewise rotationally supported and which is coupled to a second shaft, for example a chain wheel shaft of a transfer case, which is likewise not shown in the Figures. The inner disks 30 are rotationally fixedly connected to the shoulder section 20 of the clutch hub 10 by means of an inner toothed arrangement which is not shown and which engages into an outer toothed arrangement 32 of the shoulder section 20.

In the coupled state, the outer disks 28 and the inner disks 30 are brought into engagement with one another in a friction locked manner by loading with a force acting in the axial direction, to the left in FIG. 1, whereby a torque can be transmitted between the second shaft and the first shaft (or vice versa) via the clutch basket, the disks 28, 30 and the clutch hub 10. The force for the bringing into engagement of the disks 28, 30 is generated, for example, by an electrical or hydraulic actuator, with an axial bringing out of engagement of the disks 28, 30 being brought about or supported by a plate spring arrangement 34.

A plurality of bores 38 extending in the radial direction are provided in the shaft section 14 of the clutch hub 10 in the region of a rear side 36 of the first radial wall section 18. In the present embodiment, the bores 38 are arranged distributed uniformly over the periphery of the shaft section 14. The bores 38 serve as fluid inlet openings as will be explained in the following.

A corresponding number of bores 40 are provided in the shoulder section 20, with each bore 40 of the shoulder section 20 being aligned with a bore 38 of the shaft section 14 viewed in the radial direction.

The bores 38, 40 are positioned such that they are aligned with corresponding bores of the first shaft on a correct installation of the clutch hub 10 on the first shaft. The first shaft is a hollow shaft which can be flowed through by a fluid and which can be part of a fluid circuit, for example a closed fluid circuit, which also includes a transmission beside the clutch.

The fluid flowing through the first shaft can exit the first shaft via the bores of the first shaft and the bores 38, 40 of the clutch hub 10, flow through the clutch hub 10 and arrive at the disks 28, 30, as is shown in FIGS. 1 and 2 by the arrows 42 indicating the fluid flow.

In the present embodiment, the fluid is an oil which, for the purpose of lubrication and cooling, flows through both a transmission coupled to the first shaft and the shown clutch and here in particular the disks 28, 30. Since the oil, in particular after flowing through the transmission, takes along metal particles which are formed by metal wear debris and which can impair the function of the clutch, the clutch includes a particle retention device by which the metal particles carried along by the oil flowing into the clutch hub 10 are held back so that only substantially particle-free oil reaches the disks 28, 30.

The particle retention device is made in the form of a retention ring 44 which surrounds the shaft section 14 in the region of the bores 38. The retention ring 44 has an approximately U-shaped cross-section which, viewed in the radial direction, opens inwardly. In this respect, the retention ring 44 is dimensioned such that it completely covers the bores 38 of the shaft section 14 in the manner of a dome.

As can be seen from the Figures, the limbs of the U cross-section are made in different forms. The front limb 46 facing the first radial wall section 18 of the clutch hub 10, for instance, has a smaller length than the rear limb 48 facing the spring arrangement 34.

In addition, four (for example) support webs 50 which extend inwardly in the radial direction project from the wall of the retention ring 44 forming the rear limb 48. The support webs 50 are supported in a guide 52 of the shaft section 14, for example in a peripheral recess in the form of a circumferential guide groove, by a latch connection. In this respect, the guide 52 is adapted to the U cross-section of the retention ring 44 such that it is pressed in a substantially fluid-tight manner to the rear side 36 of the first radial wall section 18 by the support webs 50 engaging into the guide 52.

The length of the support webs 50 is selected such that a peripheral ring gap 56 which is only interrupted by the support webs 50 is formed between the inner margin 54 viewed in the radial direction of the wall of the retention ring 44 forming the rear limb 48 and the outer side of the shaft section 14.

A fabric insert 58 which has a fabric made of metal, e.g. steel, is arranged in an outer region of the retention ring 44 viewed in the radial direction, i.e. that is in the region remote from the bores 38 of the shaft section 14.

The operation of the particle retention device will be explained in the following.

The oil flowing through the first shaft enters via the bores 38 of the shaft section 14 into the clutch hub 10 and in particular into the interior of the retention ring 44 covering the bores 38.

The centrifugal forces resulting from the rotation of the first shaft and the clutch hub 10 act on the metal particles carried along in the oil and accelerate them in the radial direction. The metal particles thus hurled outwardly are captured by the closed outer section of the retention ring 44 and are collected in it. This section of the retention ring 44 thus fauns a retention space 60 of the particle retention device.

The oil flowing into the retention ring 44 is dammed and can only escape through the ring gap 56. In this respect, a swirl flow is formed in the particle retention device on the basis of the U-shaped cross-section of the retention ring 44 such that only at least approximately particle-free oil exits the retention ring 44 through the ring gap 56. For this purpose, the lateral passages for the oil (ring gap 56) do not necessarily have to be arranged at the same respective peripheral section of the clutch hub 10 as the fluid inlet openings (bores 38).

The metal particles are, in contrast, compressed by the centrifugal force while forming a “particle cake” in the retention space 60 and are held back in the retention ring 44, with the retention of the metal particles being additionally promoted by the fabric insert 58.

The essentially particle-free oil which has escaped from the retention ring 44 via the ring gap 56 flows outwardly past the retention ring 44 and through the bores 40 of the shoulder section 20 to flow through the disk packet 26.

It is prevented by the pressing of the retention ring 44 toward the rear side 36 of the first radial wall section 18 that the oil can exit the retention ring 44 at a different position than through the ring gap, 56 whereby an optimum separation of metal particles and oil by the retention ring 44 is ensured.

### REFERENCE NUMERAL LIST

10 clutch hub
12 longitudinal central axis
14 shaft section
16 inner toothed arrangement
18 first radial wall section
20 shoulder section
22 second radial wall section
24 rear side
26 disk packet
28 outer disk
30 inner disk
32 outer toothed arrangement
34 spring arrangement
36 rear side
38 bore
40 bore
42 direction of flow
44 retention ring
46 front limb
48 rear limb
50 support web
52 guide
54 inner margin
56 ring gap
58 fabric insert
60 retention space

1. A wet multidisk clutch comprising:
a rotatable clutch hub rotationally fixedly connected to a plurality of inner disks that are operable to be brought into engagement in friction locking with outer disks of an associated clutch basket;
at least one fluid inlet opening that enables a fluid flow from a fluid supply space to the inner and outer disks; and
at least one particle retention device arranged in a fluid flow path between the fluid inlet openings and the inner and outer disks.

2. The wet multidisk clutch in accordance with claim 1, wherein the particle retention device is radially arranged in alignment with the fluid inlet opening with respect to an axis of rotation of the clutch hub.

3. The wet multidisk clutch in accordance claim 1, wherein the particle retention device has, viewed in a radial direction, an outwardly closed retention space and at least one passage that allows a lateral exit of fluid from the retention space.

4. The wet multidisk clutch in accordance with claim 3, wherein the passage is provided in an inner region of the particle retention device viewed in the radial direction.

5. The wet multidisk clutch in accordance with claim 1, wherein the particle retention device includes a fabric insert.

6. The wet multidisk clutch in accordance with claim 5, wherein the fabric insert is arranged, viewed in the radial direction, in an outer region of a retention space of the particle retention device.

7. The wet multidisk clutch in accordance with claim 5, wherein a passage that enables a lateral exit of fluid from a retention space of the particle retention device is arranged, viewed in a radial direction, inwardly set back with respect to the fabric insert.

8. The wet multidisk clutch in accordance with claim 5, wherein the fabric insert comprises a fabric of metal.

9. The wet multidisk clutch in accordance with claim 1, wherein the particle retention device is in the form of a retention ring surrounding the clutch hub.

10. The wet multidisk clutch in accordance with claim 9, wherein the retention ring is fastened to the clutch hub by a latch connection.

11. The wet multidisk clutch in accordance with claim 9, wherein the retention ring is arranged at least in a region of the fluid inlet opening and covers the fluid inlet opening.

12. The wet multidisk clutch in accordance with claim 9, wherein the retention ring has a substantially U-shaped cross-section that is inwardly open viewed in a radial direction.

13. The wet multidisk clutch in accordance with claim 12, wherein the retention ring has a plurality of support webs that are arranged in the peripheral direction, which project from a limb of the U-shaped cross-section and extend radially inwardly.

14. The wet multidisk clutch in accordance with claim 13, wherein the support webs are dimensioned such that a respective passage through which fluid can flow out laterally from the retention ring is formed between adjacent support webs between the retention ring and the clutch hub.

15. The wet multidisk clutch in accordance with claim 13, wherein the support webs (50) are supported by a latch connection in a guide of the clutch hub.

16. The wet multidisk clutch in accordance with claim 15, wherein the guide is formed such that a side of the retention ring supported in the guide, is pressed toward a radially extending wall section of the clutch hub, the side being remote from a passage for the fluid.

17. The wet multidisk clutch in accordance with claim 15, wherein the guide is formed by a recess extending in a peripheral direction.

18. The wet multidisk clutch in accordance with claim 1, wherein the at least one fluid inlet opening is formed at the clutch hub.

19. The wet multidisk clutch in accordance with claim 1, wherein the fluid supply space has an inner space of a hollow shaft rotationally fixedly connected to the clutch hub.

20. A clutch assembly, comprising:
a hub disposed adjacent a fluid supply space having a fluid therein;
a plurality of clutch disks connected to said hub and in communication with said fluid supply space; and
a retention device coupled to said hub,
wherein said retention device retains debris in said fluid.

21. The clutch assembly of claim 20, wherein said hub includes a bore that provides a fluid flow path between said fluid supply space and said plurality of clutch disks.

22. The clutch assembly of claim 21, wherein said retention device is disposed adjacent said bore.

23. The clutch assembly of claim 20, wherein said retention device includes a ring.

24. The clutch assembly of claim 23, wherein said ring supports a fabric insert.

25. The clutch assembly of claim 20, wherein said retention device includes a fluid outlet for allowing said fluid substantially free of debris to pass therethrough.
